(19) United States
(12) Patent Application Publication
(10) Pub. No.: US 2003/0237079 A1
(43) Pub. Date: Dec. 25, 2003

(54) System and method for identifying related fields

(76) Inventors: Aneesh Aggarwal, Silver Spring, MD (US); Keith H. Randall, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/356,303

(22) Filed: Jan. 31, 2003

Related U.S. Application Data
(60) Provisional application No. 60/389,506, filed on Jun. 17, 2002.

(51) Int. Cl. G06F 9/45; G06F 9/44

(52) U.S. Cl. 717/158; 717/116; 717/108; 717/140; 717/146

(57) ABSTRACT

A system and method that establishes a list of one or more possible field pairs, which comprise an array field and an integer field of an object included in a computer program. A portion of the computer program is then scanned for references to possible field pairs included in the list. Each possible field pair corresponding to an invalid combination of references is removed from the list. An invalid combination of references precludes confirmation of an invariant relationship of a given possible field pair. The field pairs remaining on the list after this removal process are considered actual field pairs. Next, the invariant relationship of the field pairs remaining on the list is confirmed. Machine code is then generated for the computer program such that array bounds checks corresponding to a given field pair is not included in the machine code if the invariant relationship is confirmed.

This application claims priority to a provisional patent application entitled “A SYSTEM AND METHOD FOR IDENTIFYING RELATED FIELDS” bearing Ser. No. 60/389,506, attorney docket number 9772-0319-888, and a Jun. 17, 2002 filing date, which is incorporated herein by reference.

### FIELD OF THE INVENTION

The present invention relates generally to compilers in computer systems, and particularly to a system and method for determining relationships between related fields in modular object-oriented languages.

### BACKGROUND OF THE INVENTION

Modern languages such as Java™ (Registered Trademark of Sun Microsystems, Inc.) and Modula-3 provide features such as type safety, object-oriented method dispatch, and automatic memory management that improve programmer productivity, reduce bugs, and improve security. To implement these features, a compiler generates more code than would otherwise be generated. Because additional code is generated, applications written in these languages and compiled with standard optimizations are often slower than similar applications in languages such as C and Fortran. This overhead can often be eliminated by compiler optimizations. For example, a bounds check can be eliminated if the compiler can prove that the index of the array reference is non-negative and less than the length of the array.

Traditionally, compiler analyses for these optimizations have been whole-program analyses such as class hierarchy analysis, in which the entire set of classes is examined to determine the exact class hierarchy, or some type of interprocedural dataflow analysis. Both class hierarchy analysis and interprocedural dataflow analysis can increase the compile time, that is, the cost, of the program. In addition, code that was optimized using the results of class hierarchy analysis may be invalidated if the class hierarchy is modified by dynamically loading new classes. Therefore, a method and system that reduces cost by allowing a subset of the program to be analyzed, rather than the entire program, is needed. In particular, the subset of the program should be a single class or a limited set of classes.

In modern languages such as Java™, class variables are known as fields. In particular, a specific type of field is known as an instance variable. A given instance variable exists once per instance of a corresponding class. Another type of field is known as a static variable. However references to a “field”, hereinafter, are references to an instance variable.

Fields are one of several types. The present invention is concerned primarily with integer type fields (“integers”) and array type fields (“arrays”). An array is a fixed-length structure that stores multiple values of the same type. Further, array bounds checks are required in type-safe languages to make sure that applications do not inadvertently (or maliciously) write data outside the allocated portion of an array. In Java™, bounds checks throw an exception if the index of an array reference (i.e., an integer) is negative or greater than or equal to the length of the array. Each bounds check requires only a few instructions, but in tight loops that access arrays, bounds checks can add a significant overhead to program execution. The overhead of bounds checks can be eliminated, however, if at compile time it can be proven that the index of the array reference will always be in bounds.

An example of the type of bounds check that can be removed using existing techniques is illustrated in the code below:

INT ADDUP( INT [symbol] A ) {

INT X = 0;
FOR ( INT I = 0; I < A.LENGTH; I++)

X += A[I]

RETURN X;

}

In this example, information that is local to the method (i.e., procedure) ADDUP( ) is enough to deduce that the array references will always be in bounds. Specifically, the loop bound (i.e., ‘i=0; i<a.length; i++’) ensures that the variable ‘i’, which is used as an index of the array ‘a’ reference will never exceed the length of ‘a’.

But in more complicated code, traditional techniques break down because there is no obvious relationship between the loop bound and the array bound. An example of such code follows:

CLASS INTVECTOR {

INT SIZE;
INT [symbol] ELEMENTS;
INT LENGTH( ) { RETURN SIZE; }
INT ELEMENTAT( INT I) { RETURN ELEMENTS[I]; }

}

INT ADDUP(INTVECTOR V) {
INT X = 0;
FOR ( INT I = 0; I < V.LENGTH( ); I++)

X += V.ELEMENTAT( I );

RETURN x;

}

In this example, the method ADDUP( ) follows the same programming idiom as in the previous example. However, the integer array (i.e., the array of integers) has been abstracted to an INTVECTOR( ) method so that array references are hidden inside the ELEMENTAT( ) method.

A first step to prove that the array references will always be in bounds is to inline the implementations of the LENGTH( ) and ELEMENTAT( ) methods of INTVECTOR( ) into the ADDUP( ) method as follows:

INT ADDUP(INTVECTOR V) {

INT X = 0;
FOR ( INT I = 0; I < V.SIZE; I++)

X += V.ELEMENTS[I];

RETURN x;

}

But even after inlining, proving that array references will always be in bounds is difficult. In order to prove that this is so, something about the relationship between V.SIZE and V.ELEMENTS.LENGTH (i.e., whether V.SIZE is less than or equal to V.ELEMENTS.LENGTH.) must be known. There is needed in the art, therefore, a means for establishing this relationship.

### SUMMARY OF THE INVENTION

A system and method of generating code for a computer program having an object and instructions, which reference two or more fields of the object. The system and method includes identifying a field pair of the object comprising an integer field and an array field. A determination is then made as to whether the field pair has a predefined invariant relationship by reference to one or more instructions that access the field pair. Based on this determination, machine code is generated for the computer program in accordance with whether the field pair has the predefined invariant relationship.

In another embodiment of the present invention includes a system and method generating code for a computer program including an object. The system and method includes proving an invariant relationship between an array and an integer of the object. The invariant is proven if the array is null or the integer is greater than or equal to 0 and less than or equal to the length of said array. Machine code is then generated for the computer program such that a step of including a bounds check corresponding to the array and the integer is bypassed when the invariant relationship is proven.

In still another embodiment of the present invention includes a system and method of generating code for a computer program having an object. The system and method includes establishing a list of one or more possible field pairs, which comprise an array field and an integer field of the object. A portion of the computer program is then scanned for references to possible field pairs included in the list. Each possible field pair corresponding to an invalid combination of references is removed from the list. An invalid combination of references precludes confirmation of an invariant relationship of a given possible field pair. The field pairs remaining on the list after this removal process are considered actual field pairs. Next, the invariant relationship of the field pairs remaining on the list is confirmed. Finally, machine code is generated for the computer program such that array bounds checks corresponding to a given field pair is not included in the machine code if the invariant relationship is confirmed.

### BRIEF DESCRIPTION OF THE DRAWINGS

Additional objects and features of the invention will be more readily apparent from the following detailed description and appended claims when taken in conjunction with the drawings, in which:

FIG. 1 is a diagram of a computer system using the present invention.

FIG. 2 is a diagram of exemplary components of source code of FIG. 1.

FIG. 3 is a diagram of memory allocation for machine code of FIG. 1.

FIG. 4 is a diagram of the overall operation of a compiler of FIG. 1.

FIG. 5 is a diagram of an exemplary expansion of a Java™ array load instruction into an intermediate representation of FIG. 1.

FIG. 6 is a diagram of an exemplary control flow graph of FIG. 1.

FIG. 7 is a diagram of the components of a value as stored in the SSA graph in the memory.

FIG. 8 is a flowchart illustrating related field analysis in accordance with an embodiment of a compiler of FIG. 1.

FIG. 9 is a diagram of an exemplary field pair table.

FIG. 10 is a flowchart of illustrating the computation of related fields in accordance with an embodiment of a compiler of FIG. 1.

### DESCRIPTION OF THE PREFERRED EMBODIMENTS

In the present invention, a compiler uses a form of interprocedural analysis called related field analysis to reduce the costs of using modern language features such as object-oriented programming and run-time checks required for type safety. To perform related field analysis, the compiler preferably accesses a portion of the program, rather than the entire program. In particular, for a Java™ program, the compiler performs related field analysis on one or more classes of the program, rather than the entire program.

The present invention will be described with respect to an implementation of related field analysis in an optimizing compiler for Java™ to remove array bounds checks. Performance results demonstrate that related field analysis is efficient and effective. In one embodiment in which array bounds checks are removed as a result of related field analysis, application execution time was reduced by an average of approximately 2.5% for a wide range of applications, with one execution time reduced by approximately 3.3%. Note that the average execution time reduction resulting from removal of all array bounds checks is 5%.

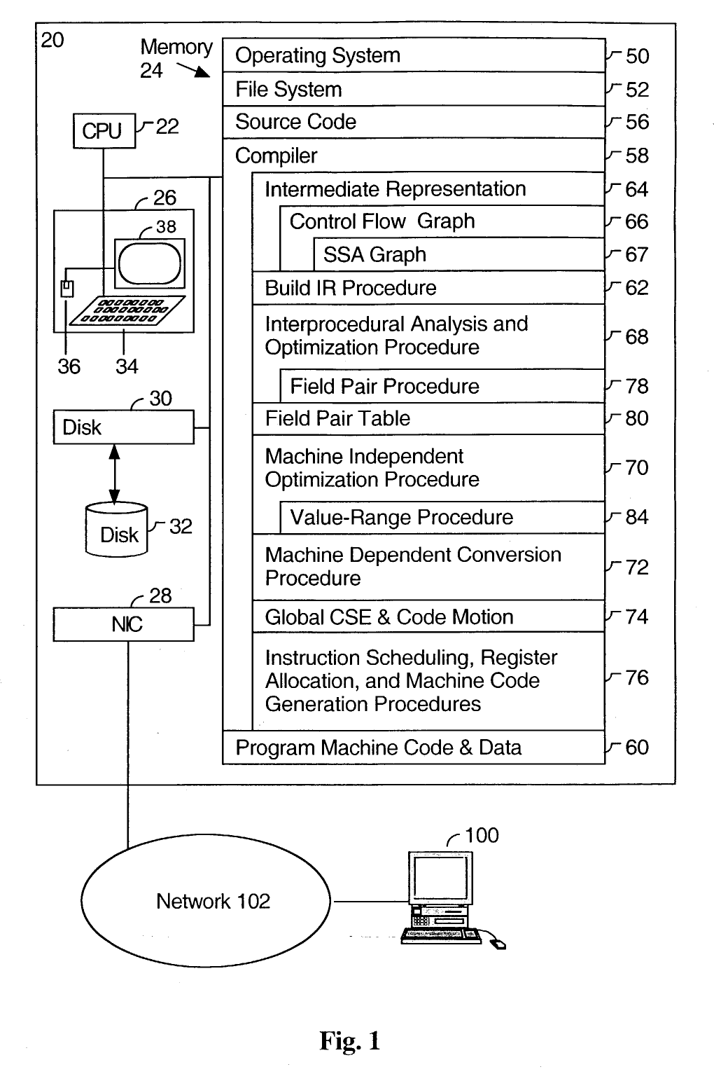

As shown in FIG. 1, in a computer system 20, a central processing unit (CPU) 22, a memory 24, a user interface 26, a network interface card (NIC) 28, and disk storage system, including a disk controller 30 and disk drive 32, are connected by a system bus 33. The user interface 26 includes a keyboard 34, a mouse 36 and a display 38. The memory 24 is any suitable high speed random access memory, such as semiconductor memory. The disk drive 32 may be a magnetic, optical or magneto-optical disk drive.

The memory 24 stores the following procedures and data:

an operating system 50, such as UNIX;

a file system 52;

a source code program 56; in one embodiment, the source code program 56 is a Java™ bytecode program;

a compiler 58 in accordance with an embodiment of the present invention; in one embodiment, the compiler is a Java™ compiler; and

program machine code and data 60.

The compiler 58 procedures and data include:

a build intermediate representation (IR) procedure 62 that generates an intermediate representation 64 of portions of the source code program 56; the intermediate representation 64 includes a control flow graph (CFG) 66 and a static single assignment (SSA) graph 67;

an interprocedural analysis and optimization procedure 68 in accordance with an embodiment of the present invention that includes a field pair procedure 78;

a field pair table 80 to store possible field pairs;

a machine-independent optimization procedure 70, which includes a value-range procedure 84;

a machine-dependent conversion procedure 72;

a global common subexpression elimination (CSE) & code motion procedure 74; and

an instruction scheduling, register allocation and machine code generation procedure 76 that generates the machine code 60.

The procedures of the compiler 58 will be further described below with reference to FIGS. 4 and 8-10.

The programs and procedures of FIG. 1 include one or more instructions. The programs, procedures and data stored in the memory 24 may also be stored on the disk 32. Furthermore, portions of the programs, procedures and data shown in FIG. 1 as being stored in the memory 24 may be stored in the memory 24 while the remaining portions are stored on the disk 32.

The computer system 20 is connected to a remote computer 100 via a network 102 and network interface card 28. The remote computer 100 may have the same or similar components as local computer 20. In one embodiment, the compiler 58 of the present invention is downloaded from the remote computer 100 via the network 102.

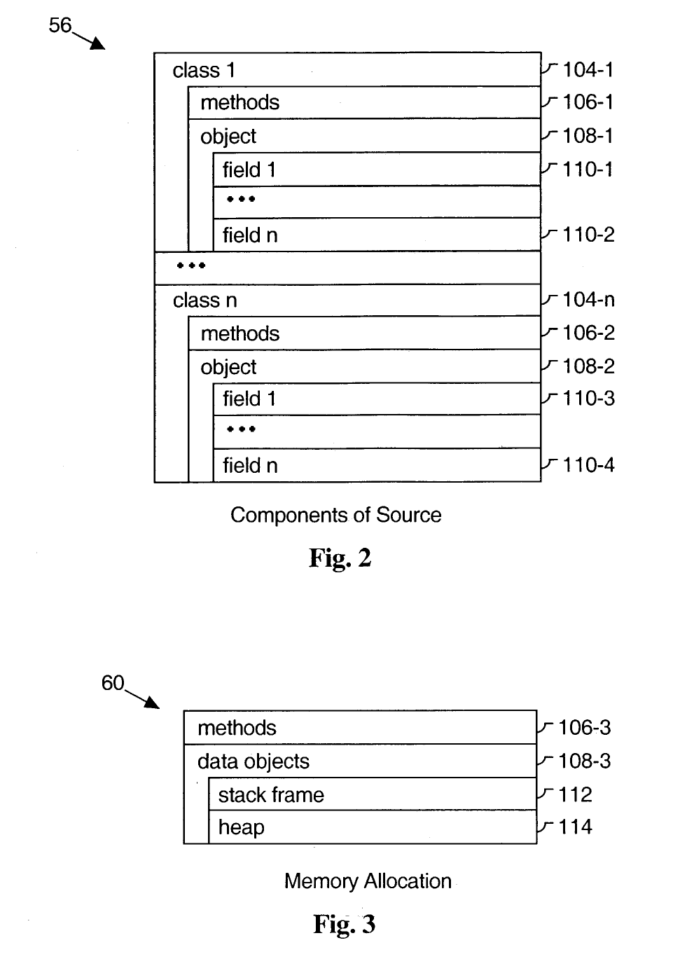

FIG. 2 is a diagram of exemplary components of source code program 56 of FIG. 1. The source code program 56 has one or more classes 104. Each class 104 includes one or more methods (i.e., executable procedures) 106 and one or more objects 108. Each object 108 includes one or more fields 110.

A field 110 is a component of an object in an object-oriented language, occupying a “slot” of the object's data structure. As noted above, a field 110 is sometimes called an instance variable, since it is a component of a particular object instance whose contents can be read and written. In most object-oriented languages, each specific object is a member of a class, which gives a general description of the fields in the object and the methods that can operate on the object.

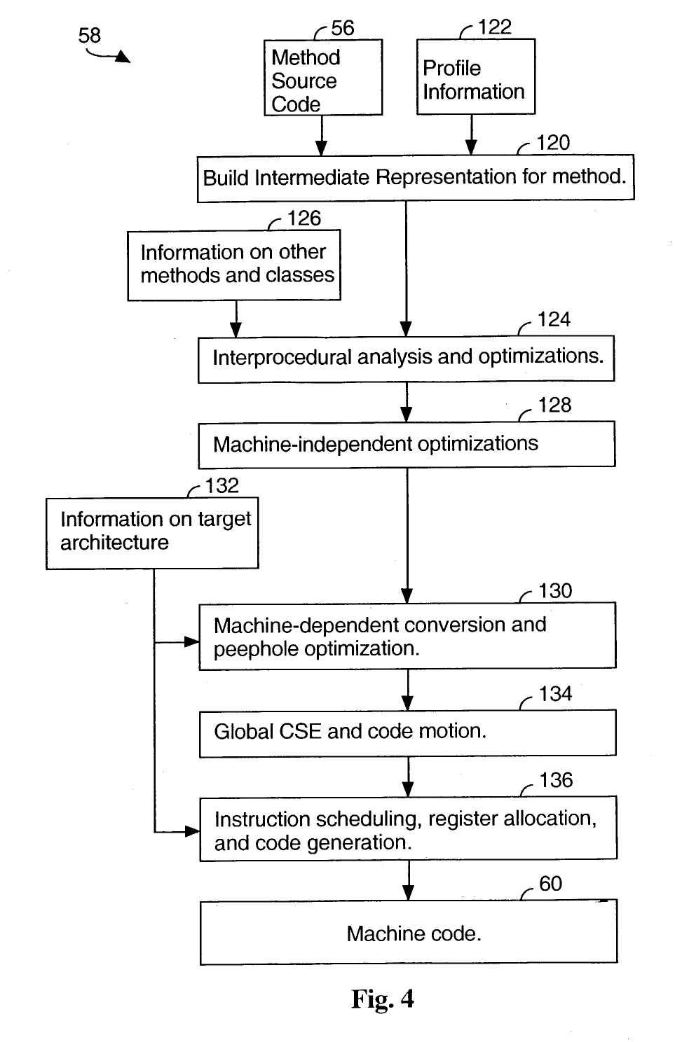

FIG. 3 is a diagram of memory allocation for the machine code 60 of FIG. 1. The memory 24 (FIG. 1) includes machine code instructions implementing one or more methods 106, and space allocated for one or more data objects 108. The data objects 108 may be stored in a stack frame 112 or a heap 114. Every invocation of a method 106 is associated with a stack frame 112. The stack frame 112 stores variables local to a method invocation and sometimes stores objects that will only be used while the method call is active. The heap 114 stores global objects and objects accessed by multiple methods.

The Organization of the Compiler

FIG. 4 is a diagram of the organization of the compiler 58 of the present invention. In block 120, the build IR procedure 62 (FIG. 1) builds an intermediate representation 64 including the control flow graph 66 for a method based on the source code program 56 (e.g., a Java™ bytecode program). Profile information 122, if any, is used to annotate the control flow graph 66 (FIG. 1) of the method. In preferred embodiments of the present invention, one or more methods (e.g., a helper method) called from a method 56 that is the basis of the intermediate representation 64, may be inlined into the method. More specifically, an intermediate representation is built from, for example, a helper method and inserted into the intermediate representation 64. Whether a method is inlined typically depends on whether the method can be resolved and whether the size of the method is below a certain threshold. In block 124, the interprocedural analysis and optimizations procedure 68 (FIG. 1) applies interprocedural optimizations, including a portion of the related field analysis of the present invention, to the intermediate representation 64 (FIG. 1) to generate field-analyzed code. The interprocedural analysis and optimizations procedure 68 (FIG. 1) receives information on other methods and classes from block 126. In block 128, the machine-independent optimization procedure 70 (FIG. 1) performs one or more machine-independent optimizations, including another portion of the related field analysis of the present invention, to the field-analyzed code to produce adjusted field-analyzed code. In block 130, the machine-dependent conversion procedure 72 (FIG. 1) receives information on the target machine architecture 132 and converts the adjusted, field-analyzed code to machine-dependent code using a tree-matching algorithm and performs peephole optimizations. In block 134, the global common subexpression elimination (CSE) and code motion procedure 74 (FIG. 1) performs additional optimizations on the machine-dependent code to take advantage of opportunities exposed by machine-dependent form and generates adjusted machine-dependent code. In block 136, the instruction scheduling, register allocation, and code generation procedures 76 (FIG. 1) receive information on the target machine architecture 132 and generate the target machine code 60 from the adjusted machine-dependent code.

In one implementation, the compiler 58 is written in Java™ and translates Java™ bytecodes (i.e., a Java bytecode program) into Compaq Alpha machine code.

Many of the above mentioned steps performed by the compiler 58 represent, at least in part, steps performed by many compilers and thus are well known to those skilled in the art of compiler design. The discussion below will focus primarily on the aspects of the compiler of the present invention that are distinct from compilers known in the prior art.

Building the Intermediate Representation

The compiler 58 generates the intermediate representation from the source code 56 of a method, which in the preferred embodiment is a Java™ bytecode program. First, the bytecode program is scanned to determine the number of basic blocks and edges between the basic blocks. A phi node placement algorithm is executed to determine which local variables of the Java™ virtual machine require phi nodes in the basic blocks. Persons skilled in the art recognize that typical intermediate representations, such as an SSA (static single assignment) graph, transform the uses of internal temporaries so that they are only assigned to once. For example, the following code:

IF (SOME CONDITION) A=1;

ELSE A=2;

B=A;

after transformation becomes

IF (SOME CONDITION) A1=1;

ELSE A2=2;

B=????

The problem is determining whether the value of A1 or A2 should be assigned to B. To address this problem, the code is typically modified as follows:

IF (SOME CONDITION) A1=1;

ELSE A2=2;

B=PHI(A1, A2);

The phi statement forces the compiler 58 to determine which value (e.g., a1 or a2) is the correct value to use based on the control flow.

The bytecodes of each of the basic blocks are executed via abstract interpretation, starting with the initial state of the local variables upon method entry. The abstract interpretation maintains an association between Java™ virtual machine local variables and static single assignment (SSA) values, determines the appropriate inputs for new values, and builds the SSA graph.

The compiler 58 preferably performs some optimizations while building the SSA graph to reduce the number of nodes. The compiler 58 replaces an array 110 length operation with the allocated size of an array 110, if the array 110 was allocated in the current method. The compiler 58 also eliminates bounds checks if the index and array length are constant. These optimizations are especially important in methods (such as class initialization methods) that initialize large constant-sized arrays 110. In FIG. 4, block 120, the compiler 48 also uses profile information 122 produced by previous executions of the code to annotate the edges of the control flow graph indicating their relative execution frequency. If no profile information is available, the compiler 58 estimates reasonable execution frequencies based on the loop structure of the control flow graph. The execution frequencies are used for decisions about code layout and choosing traces by a trace scheduler.

Representation of a Method

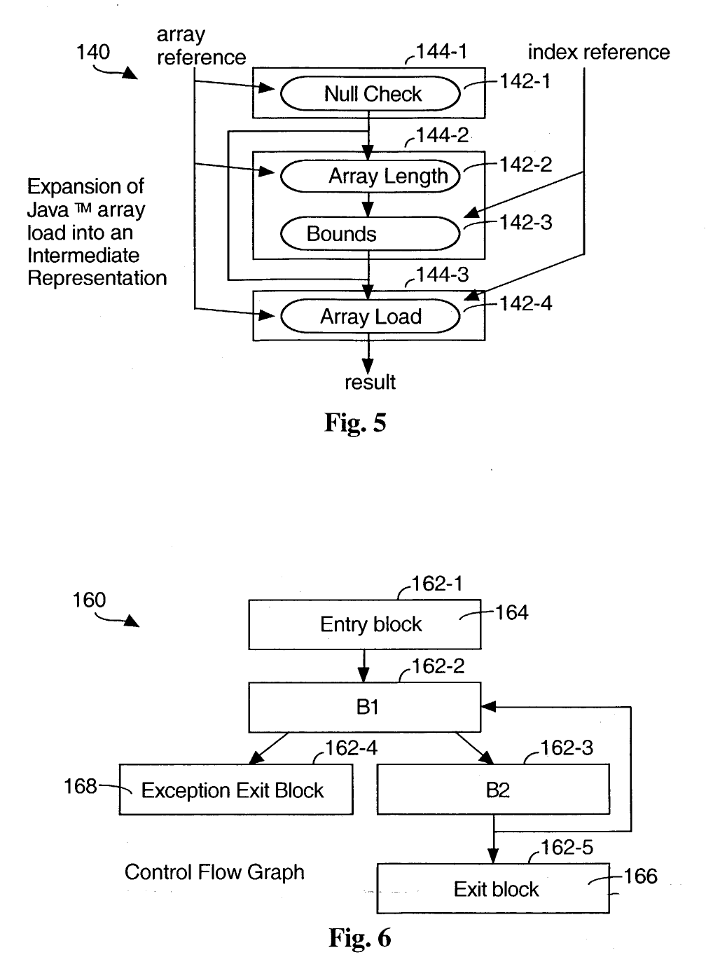

Referring to FIG. 5, in an intermediate representation, a method is represented by a static single assignment (SSA) graph 140 embedded in the control flow graph (FIG. 6). The structure of the SSA graph 140 of FIG. 5, the structure of the control flow graph of FIG. 6, and the relationship between the SSA graph and control flow graph will be described.

The Static Single Assignment Graph

In FIG. 5, an exemplary static single assignment (SSA) graph 140 for a load operation is shown. The SSA graph 140 has nodes 142, referred to as values, that represent individual operations. The ovals 142 represent the nodes or SSA values, and the boxes 144 represent blocks in the control flow graph. A value may have one or more inputs, which are the result of previous operations, and has a single result, which can be used as an input for other values.

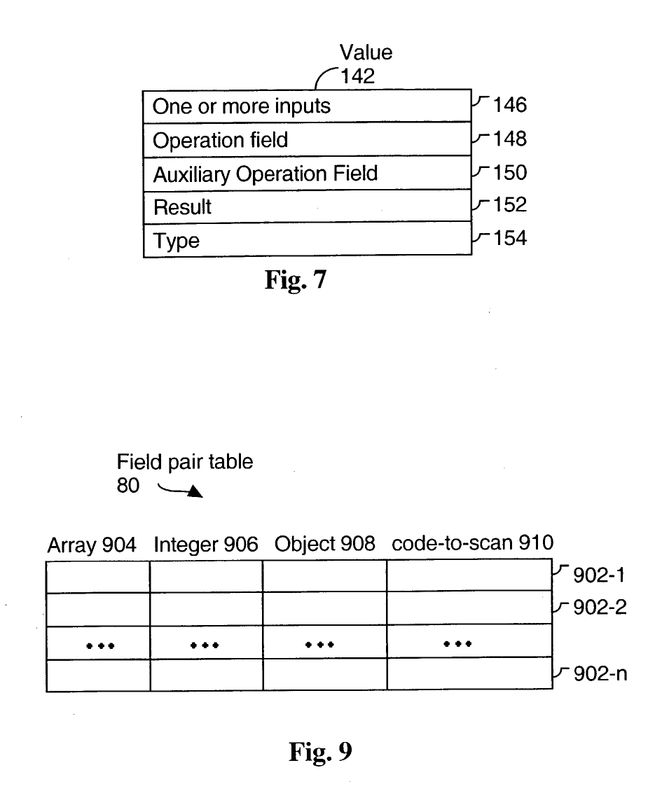

In FIG. 7, the components of a value 142 are shown as stored in the SSA graph 140. Each value 142 has one or more inputs 146, an operation field 148, an auxiliary operation field 150, a result 152 and a type 154. The operation field 148 indicates the kind of operation that the value represents. For example, if the operation field 148 is “add,” the value 142 represents an operation that add, for example, two inputs 146 to produce a result 152. The auxiliary operation field 150 specifies additional static information about the kind of operation. For example, if the operation field 148 is “new,” the value 142 represents an operation that allocates a new object, and the auxiliary operation field 150 specifies the class of the object to be allocated. If the content of the operation field 148 is “constant,” the value 142 represents a numeric or string constant and the auxiliary operation field 150 specifies the constant.

An intermediate representation includes separate operations for run-time checks typically required by programming languages (e.g., Java™). The compiler 58 has individual operations representing null checks, bounds checks, and cast checks. These operations cause a run-time exception if their associated check fails. A value 142 representing a run-time check produces a result that has no representation in the generated machine code. However, other values 142 that depend on a run-time check take its result as an input to ensure that these values are scheduled after the run-time check. Still, representing the run-time checks as distinct operations allows the compiler 58 to apply optimizations, such as common subexpression elimination on two null checks of the same array, to the run-time checks.

In particular, FIG. 5 shows the expansion of a Java™ array load into an intermediate representation. An array and index are the values input into an array load operation. Java™, and other languages, typically require a null check and a bounds check before an element is loaded from an array 110 (see fields 110 in FIG. 2). The null check (null_ck) value takes the array 110 as input, and throws a NullPointerException if the array is null. The array length (arr_length) value takes the array 110 and the associated null check value as input, and produces a length of the array 110. The bounds check (bounds_ck) value takes the length of the array 110 and an index into the array 110 as inputs. The bounds check value throws an ArrayindexoutOfBounds Exception when the index is not within the bounds of the array 110 (e.g., exceeds the length of the array). The array load (arr_load) value takes an array, an index into the array, an associated null check value, and an associated bounds check value as input and returns the specified element of the array 110.

The compiler 58 also has a value named init_ck that is an explicit representation of the class-initialization check that precedes some operations. This value checks whether a class has been initialized, and calls the class initialization method if not. Operations that load a class variable or create a new object, perform an initialization check of the associated class. Calls to class methods also perform the initialization check, which is handled by the initialization code of the class method. During optimization, the compiler 58 will often eliminate redundant initialization checks. For example, the Java™ virtual machine replaces initialization checks that are identical and subsequent to a first such initialization check with no-operation codes (“NOP”).

The intermediate representation also includes machine-dependent operations that represent, or map very closely to specific target-machine instructions. For example, one pass of the compiler 58 converts many of the machine-independent operations into one or more machine-dependent operations. The conversion to machine-dependent operations or values allows for greater optimization and the direct operation of the instruction scheduling, register allocation, and code generation passes on the SSA graph 67 (FIG. 1).

The SSA graph 67 (FIG. 1) is a factored representation of the use-def chains for all variables in a method, since each value explicitly specifies the values used in computing its result. When building the SSA graph 67 (FIG. 1), the compiler 58 also builds def-use information and updates the def-use chains when the graph is manipulated. Therefore, an optimization can, at any stage, directly access all the users (i.e., instructions or bytecodes that use) of a particular value.

Representing Control Flow

In FIG. 6, an exemplary control flow graph 160 is shown. The compiler 58 preferably represents a method as an SSA graph embedded within the control flow graph 160. Each block 144 of the SSA graph corresponds to a specific block 162 of the control flow graph 160, although various optimizations may move values 142 among blocks 162 or even change the control flow graph 160. A block 162 in the control flow graph 160 may have zero or more incoming edges and zero or more outgoing edges. Some of the outgoing edges may represent control flow that results from the occurrence of an exception. These edges are labeled with the type of exception that causes flow along that edge.

Each control flow graph 160 typically has a single entry block 164, a single normal exit block 166, and a single exception exit block 168. The entry block 164 includes the values 142 representing the input arguments of the method. The normal exit block 166 includes the value representing the return operation of the method. The exception exit block 168 represents the exit of a method that results when an exception, not caught within the current method, is thrown. Because many operations can cause run-time exceptions in Java™ and these exceptions are not usually caught within the respective method in which the exception occurs, many blocks have an exception edge to the exception exit block 168. Blocks B1 162-2 and B2 162-3, respectively, form a loop. Block B1 162-2 has an exception exit and is connected to the exception exit block 168. Block B2 162-3 is connected to the normal exit block 166.

The compiler 58 uses the standard definition of a basic block. Each block 162 is a basic block. All blocks 162 end when an operation with two or more control exits is reached. An operation that can cause an exception is therefore always located at the end of a basic block 162.

Many types of values affect the control flow of a program. An “if” node takes a boolean value as input and determines the control flow out of the current block based on that input. A “switch” node determines control flow based on integer input. Operations that may cause an exception include method calls, run-time checks, and object or array 110 allocations.

Each block 162 has a reference to a distinguished value, called the control value. For a block that has more than one outgoing edge, the control value is the value that controls the program flow or that may cause an exception. The control value of the normal exit block 166 is the return value. Simple blocks with a single outgoing edge have no control value. The control value field of a block 162 provides access to the exception-causing or control-flow value of the block. In addition, a set of control values indicates the base set of values in a method that are “live,” because those values are used in computing the return value and for controlling program flow. Other live values are determined recursively based on the input of this base set. The compiler 58 performs dead code elimination of values that are no longer needed in accordance with the “live” blocks as indicated by the set of control values.

Control values of a block cannot be moved from their block, and are often referred to as “pinned.” Phi nodes are pinned; and operations that write to the global heap are pinned. All other operations are not pinned, and may be moved freely among blocks, as long their data dependencies are respected.

In one implementation, the Java™ virtual machine has bytecodes (i.e., instructions) that perform light-weight subroutine calls and returns within a method. These bytecodes are used to implement “finally” statements without duplicating bytecodes. However, these subroutines complicate control flow and data flow representations. Therefore, in a preferred embodiment the compiler inlines these subroutines in the intermediate representation. Although the control flow graph may grow exponentially if there are multiply nested finally clauses, in practice, such an event is unlikely. In an alternate embodiment, the aforementioned subroutines are not inlined.

The Type System

As shown in FIG. 7, every value in the SSA graph has a type 154 (sometimes called a data type). In one implementation, the type system represents all of the types (e.g., array, integer, etc.) present in a Java™ program. The type of each value is determined as the compiler builds the SSA graph from the method's bytecodes. The bytecodes for a method do not always have sufficient information to recover the exact types of the original Java™ program. However, it is possible to assign a consistent set of types to the values such that the effects of the method represented by the SSA graph are the same as the original method. Although Java™ does not make use of an explicit boolean type, the compiler assigns a type of boolean to a value when appropriate. The boolean type indicates an integer value that can only be equal to zero or one, and enables certain optimizations that do not apply to integers in general.

For some operations, the value's type further specifies the operation and therefore affects the specific machine code generated. For example, the generic add operation can specify an integer, long or floating point addition, depending on its result type. Information about a value's type can also help optimize an operation that uses that value. For example, the compiler may be able to resolve the target of a virtual method call if the compiler has more specific information about the type of the method call's receiver.

The type system includes additional information that facilitates optimizations. The compiler allows specification of the following additional properties about a value with a particular Java™ type T:

1. the value is known to be an object of exactly class T, not a subclass of T;

2. the value is an array 110 with a particular constant size; and

3. the value is non-null.

By incorporating these properties into the type system, the compiler can describe properties of any value in the SSA graph by its type. In addition, the compiler indicates properties for different levels of recursive types, such as arrays 110. In an alternate embodiment, the type system also includes union types, which specify, for example, that a particular value has either type A or type B, but no other type.

Related Field Analysis

The Invariant

Related field analysis can be viewed as proving an invariant about related fields. The general framework for related field analysis allows for many different types of invariants, depending on their usefulness in optimization. Preferred embodiments of the present invention are directed to invariants that enable the removal of array bounds checks from the machine code generated by the compiler.

The invariant used in preferred embodiments of the present invention is parameterized by two fields 110 (FIG. 2), an array and an integer, of a common class 104. The invariant is as follows: (array=null) or (0<=integer<=array.length), where array.length represents the length of the array. This invariant captures the situation where the array contains elements of a set, list, or other data structure, and the integer contains the number of elements which are valid in the array 110. The following REMOVELASTELEMENT( ) method is a list abstraction and illustrates the usefulness of the invariant:

OBJECT REMOVELASTELEMENT( ) {

IF (INTEGER >= 1) RETURN ARRAY[--INTEGER];
ELSE RETURN NULL;

}

The method maintains the integer as the number of elements of the array 110 that belong to the list. If the invariant is proven, then it is known upon entry to this method that either the array is null or 0<=integer<=array.length. In the former case, a NullPointerException will be thrown and the array bounds check is unnecessary. In the latter case, combining the invariant with the branch condition (i.e., INTEGER>=1) proves that the reference (i.e., ARRAY[—INTEGER]) will always pass an array bounds check. In either case, therefore, the array bounds check is unnecessary (with respect to the array for which the invariant was proven) and can be removed from the intermediate representation 140 and machine code 60 generated by the compiler 58.

Selecting Portions of Source Code to Analyze

In preferred embodiments, an attempt is made to prove the invariant for each related field (a.k.a. a field pair) included in the source code program 56 (sometimes called “the source code” for convenience). Each unique combination (i.e., pairing) of an array field and an integer field corresponding to a given object 108 of a class 104 in the source code program 56 is a possible field pair. In certain embodiments (e.g., embodiments using Java™ bytecode programs), field declarations for each class 104 are located in predefined sections of the source code 56. This permits these embodiments of the present invention to easily populate a field pair table 80 (FIG. 1) with possible field pairs for a class 104. Additionally, the compiler 58 preferably uses field 110 modifiers (e.g., Java™ field modifiers) to select a subset of the source code 56 that is checked for references to a given field 110. This mechanism is summarized in Table 1 below.

TABLE 1

| Class | Field Modifier | Code to scan |
|---|---|---|
| public | private | containing class |
| public | package | containing package |
| public | protected | containing package and subclasses |
| non-public | private | containing class |
| non-public | non-private | containing package |

The first and second columns of Table 1 include the class and field modifier, respectively, and the third column describes the subset of the source code 56 that is scanned for accesses to a field 110 with the specified modifiers. Fields that are final are handled more efficiently than the rules given in Table 1 would imply: normal rules are used for finding all the reads of a final field, but only the containing class is scanned for writes to the field 110. Note that for a protected field 110 in a public class, the compiler 58 scans all subclasses of the public class. Because dynamic loading could introduce new subclasses of the public class, the compiler analyzes such fields 110 only if class hierarchy analysis is also being used by the compiler. Public fields in public classes are handled by scanning the entire program. In one implementation, the compiler ignores public fields in public classes for efficiency considerations; in another implementation the compiler scans the entire program for public fields.

Dynamic loading could potentially create problems in the handling of package-visible fields by introducing a new class into the package. However, if the package is associated with a class loader that loads from a predetermined portion of the file system, the compiler scans that portion of the file system to be sure that dynamic loading will not introduce any new classes into that package. Packages associated with the three most widely used class loaders, namely the system loader, the extension loader and the user CLASSPATH loader, are handled in this way.

Computing Related Fields

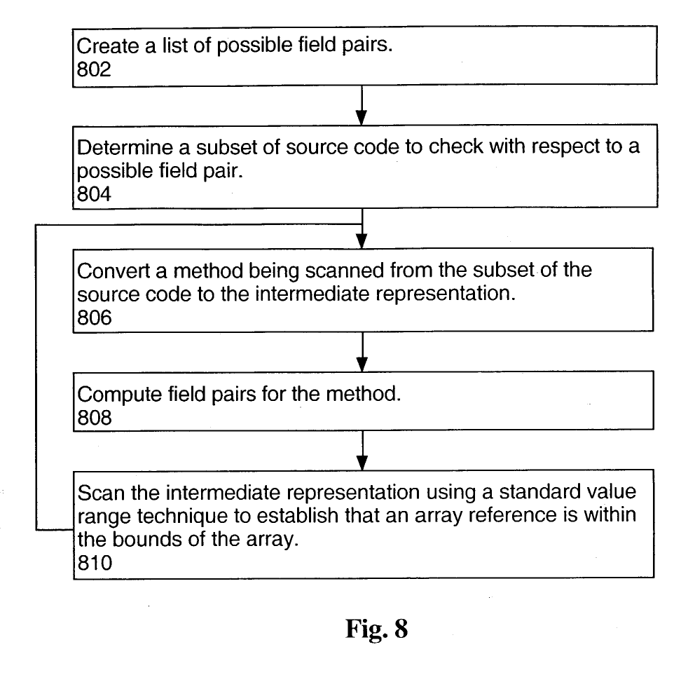

In preferred embodiments, whether two fields 110 (e.g., a possible field pair) are related fields is determined by looking at all assignments to, modifications of, and reads from the two fields 110 (FIG. 4, block 124). Importantly, it is assumed that the invariant holds upon entry to method 106 and at the return point of every invocation of a method 106, but the compiler 58 proves (or attempts to prove) that the invariant holds at the call point of every invocation and on method exit. Note that newly allocated, but not yet constructed, objects are initialized to a state that satisfies the invariant (i.e., initialized to null). More specifically, the compiler 58 determines whether the array field 110 or the integer field 110 is modified between reads of the array 110 and the integer 110. If such modifications are detected or the compiler 58 is unable to determine that they do not take place, the possible field pair(s) corresponding to such modifications are removed from the field pair table 80. The steps taken by the compiler 58 in a preferred embodiment of the present invention are described in detail below with reference to FIGS. 8-10.

Removing Array Bounds Checks

After computing field pairs, one or more field pairs may remain in the field pair table 80. In a subsequent optimization phase (e.g., block 128), every array reference in the source code 56 corresponding to a field pair included in the field pair table 80 is analyzed by the compiler 58 to determine whether an associated bounds check can be removed. In particular, the compiler employs standard value-range techniques augmented with information about the invariant to determine whether the index used in the array 110 reference is non-negative and less than the integer field 110 of each field pair corresponding to the array reference. The standard value-range technique in a preferred embodiment of the invention is an intraprocedural dataflow analysis. To illustrate the operation of a standard value-range technique, consider the following loop:

FOR(INT INDEX=0; INDEX<INTEGER; INDEX++) x+=ARRAY[INDEX];

To prove that the array bounds check is unnecessary, the compiler 58 analyzes the inequality index is less than integer (from the loop bounds) together with the inequality integer is less than or equal to the length of the array (from the invariant) to infer the inequality index is less than the length of the array. This fact, together with the inequality index greater than or equal to zero (from the loop bounds), is enough to prove that index is within the bounds of the array. As a result, the array bounds check for this array reference is not required and removed.

Attention now turns to a more detailed description of a preferred embodiment of the present invention with reference to FIGS. 8, 9, and 10. In a first step, the compiler 58 populates the field pair table 80 (FIG. 9) with possible field pairs (step 802, FIG. 8). As indicated above, the fields 110 of a given class 104 are typically declared/listed in a predefined location within the class 104 (FIG. 2). The compiler 58 references this section of the class 104 to obtain possible field pairs (e.g., each unique combination of arrays and integers corresponding to a given object 108 within the class 104). The compiler 58 also determines, in association with each field pair, the subset of the source code 56 to scan with respect to the field pair (step 804). For example, if one of the fields 110 of a field pair is valid in fewer sections of the source code 56, the compiler 58 checks only these sections in conjunction with the corresponding field pair. FIG. 9 illustrates a field pair table 80 in accordance with a preferred embodiment of the present invention. The field pair table 80 includes a plurality of rows (i.e., field pair entries) 902. Each row 902 includes a plurality of columns including an array column 904, an integer column 906, an object column 908, and a code-to-scan column 910. The first two columns store identifiers of the array 110 and the integer 110 that comprise a corresponding field pair. The third column identifies the object 108 to which the field pair corresponds. The last column indicates sections of the source code 56 to scan with respect to the corresponding field pair. In alternate embodiments, the compiler 56 just identifies the sections of the source code 56 that must be scanned with respect to all of the entries 902 in the field pair table 80, and then scans this section in conjunction with all of the possible field pairs even though some of the field pairs might not be found in certain subsections of the identified sections of the source code 56.

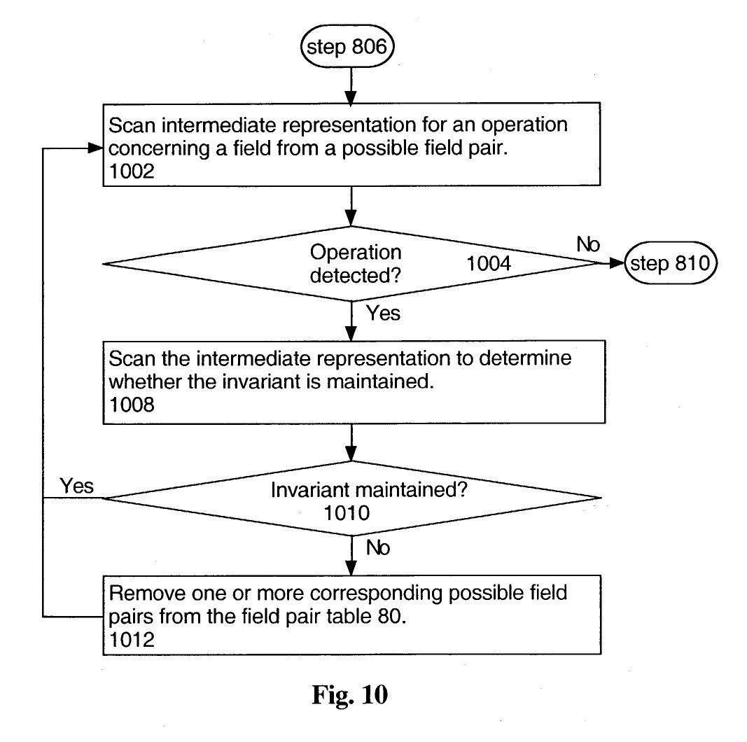

The compiler 58 then converts a method included in a subset of the source code 56 to the intermediate representation as described above in conjunction with FIG. 4 in general and block 120 in particular (step 806). The compiler 58 then computes field pairs for the intermediate representation of the method (step 808). The various sub-steps included within step 808 are described in detail with reference to FIG. 10. The compiler 58 begins by scanning the intermediate representation for an operation concerning a field 110 from a possible field pair (step 1002). Preferably, the compiler searches for modifications of an integer 110 (e.g., INTEGER=2*ARRAY.LENGTH) and modifications of the array 110 that may alter the length of the array 110 (e.g., ARRAY=NEW INT[2*ARRAY.LENGTH]). If such an operation is detected, the compiler 58 scans the field pair table 80 to determine whether a subject of the operation is a field 110 included in the field pair table 80. If no such operation is detected (i.e., no operation that corresponds to a possible field pair included in the field pair table 80) (step 1004-No), the compiler 58 moves on to step 810, which is described below.

But if such an operation is detected (step 1004-Yes), the compiler 58 scans the intermediate representation to determine whether the invariant is maintained (step 1008). For example, if the operation detected in step 1004 is an assignment of a null pointer (i.e., a null value) to the array 110, the invariant is trivially maintained (in languages such as Java™, arrays 110 set to a null pointer can not be accessed so an array bounds checks is unnecessary).

If the array 110 is not assigned a null pointer, the compiler 58 determines whether the length of the array 110 is at least the value of the integer 110 (note that the compiler 58 takes this step for each possible field pair that includes the array 110). Again, possible field pairs preferably comprise each unique combination of arrays 110 and integers 110 corresponding to a given object 108 within the class 104 so one or more arrays corresponding to the object 108 may be part of a plurality of possible field pairs). In particular, if the operation detected in step 1002 is the assignment of newly allocated array to the array field 110, the compiler 58 determines whether the length of the newly allocated array is derived by a function of the form

f(x)=c1x+c2,

where c1>=1, c2>=0, and x is either the value of an integer 110 or the old length of the array 110. If x is the value of the integer 110, this function ensures that the new length of the array 110 is at least the value of the integer 110. Less obvious are instances in which x is the old length of the array 110. Recall, that it is assumed that the invariant holds on method 106 entry, so it is also assumed that the old length of the array 110 is at least the value of the integer 110. Increasing the length of the array 110 using the function above maintains the invariant with respect to the array 110 that is the subject of the operation detected in step 1002.

And in preferred embodiments of the present invention, the compiler does not scan the entire method 106 to determine whether the length of the array 110 is at least the value of the integer 110. Instead, the compiler 58 scans forward and backward from the operation detected in step 1004 until certain types of operations are detected (i.e., invariant invalidating operations). For example, the compiler 58 preferably stops scanning in a particular direction once a call to a method of indeterminate content, a branch instruction, a write to the array 110, or an assignment to the array 110 or the integer 110 is detected. Any of these operations—together with the operation detected in step 1004—effectively form an invalid set of operations (i.e., a set of operations not separated by an operation that maintains the invariant).

So if the operation detected in step 1002 is an assignment of a newly allocated array to another array 110 (i.e., an array 110 included in a possible field pair), but the compiler 58 does not determine that the length of the newly allocated array is derived by the function illustrated above (step 1010-No), the compiler 58 removes each entry 902 corresponding to the array 110 from the field pair table 80 (step 1012).

Note, however, even if the compiler determines that the length of the newly allocated array is derived by the function illustrated above and x is the value of an integer 110, the compiler 58 removes each entry 902 corresponding to the array 110 in combination with any other integer field (i.e., other than the integer 110 used in the function to derive the new length of the array) from the field pair table 80 (step 1012). The invariant, therefore, is maintained only with respect to one field pair.

But if the operation detected in step 1002 is an assignment of something other than a newly allocated array to the array 110 (e.g., ARRAY=ARRAY2), the compiler 58 scans for an assignment of either the numerical value zero or the new length of the array 110 to the integer 110 (i.e., each integer 110 of a possible field pair including the array 110). As described above, the compiler 58 preferably does not scan the entire method—the compiler 58 preferably stops scanning in a particular direction once a call to a method of indeterminate content, a branch instruction, a write to the array 110, or an assignment to the array 110 or the integer 110 is detected. The compiler 58, moreover, preferably does not stop scanning until one of these operations is encountered or all possible field pairs concerning the array 110 are accounted for. It is possible that the length of the new array 110 is assigned to more than one integer 110. If so, the invariant is maintained for more than one possible field pair. In this instance, therefore, the compiler 58 removes each field pair entry 902 corresponding to the array 110 and an integer 110 that is not assigned the new length of the array 110 or zero (possibly all of the entries 902 corresponding to the array 110) (step 1012).

If the operation detected in step 1002 concerns an integer 110, the compiler 58 still determines whether the invariant is maintained (step 1008). For example, the compiler 58 scans the intermediate representation for a preceding conditional branch. If, for example, the assignment to the integer 110 decrements the integer 110 by k, the compiler 58 scans the intermediate representation to determine whether the operation detected in step 1002 occurs on the branch of a conditional instruction of the form INTEGER>=K. This ensures that the integer 110 is greater than or equal to zero, a requirement of the invariant. Again, it is assumed that the invariant holds on method 106 entry, so it is assumed that the old length of the array 110 is at least the value of the integer 110. Decreasing the value of the integer 110 will not destroy this equality. Additionally, the compiler 58 preferably does not scan the entire method. Instead, the compiler 58 preferably stops scanning in a particular direction once a call to a method of indeterminate content, a branch instruction, a write to the array 110, or an assignment to the array 110 or the integer 110 is detected. So if the compiler 58 is unable to determine that the operation detected in step 1002 occurs on the branch of a conditional instruction of the form INTEGER>=K (i.e., unable to determine that the invariant is maintained) (step 1010-No), the compiler 58 removes field pairs corresponding to the integer 110 from the field pair table 80. But if the compiler 58 is able to determine that the operation detected in step 1002 occurs on the branch of a conditional instruction of the form INTEGER>=K (step 1010-Yes), the compiler 58 returns to step 1002 to continue scanning the intermediate representation for an operation concerning a field 110 from a possible field pair.

And if the assignment to the integer 110 increments the integer 110 by k, the compiler 58 scans the intermediate representation to determine whether the operation detected in step 1002 occurs on the branch of a conditional instruction of the form INTEGER<=ARRAY.LENGTH+K. This ensures that the integer 110 is still less than or equal to the length of the array 110, a requirement of the invariant. The compiler 58 preferably does not scan the entire method to make this determination. Instead, the compiler 58 preferably stops scanning in a particular direction once a call to a method of indeterminate content, a branch instruction, a write to the array 110, or an assignment to the array 110 or the integer 110 is detected. So if the compiler 58 is unable to determine that the operation detected in step 1002 occurs on the branch of a conditional instruction of the form INTEGER<=ARRAY.LENGTH+K (i.e., unable to determine that the invariant is maintained) (step 1010-No), the compiler 58 removes field pairs corresponding to the integer 110 from the field pair table 80. But if the compiler 58 is able to determine that the operation detected in step 1002 occurs on the branch of a conditional instruction of the form INTEGER<=ARRAY.LENGTH+K (step 1010-Yes), the compiler 58 returns to step 1002.

After computing field pairs for the intermediate representation (steps 808, 1002-1012), the compiler 58 scans the intermediate representation using a standard value-range technique (augmented by the invariant) to establish that array references (i.e., reads from an array 110 or writes to an array 110) corresponding to an array 110 included in a field pair maintained in the field pair table 80 (i.e., an actual field pair) are within the bounds of the array (step 810) as described above. If the compiler determines that an array reference is within the bounds of the array 110, the corresponding array bounds check (e.g., 142-3, FIG. 5) in the intermediate representation of the program is replaced by a NOP. As a result the array bounds check is removed from the machine code generated by the compiler.

The compiler 58 then continues processing methods 106 in a given class 104 as described above with reference to steps 806-810 until each method 106 included in the subset of the source code 56 selected in step 804 is processed. And after a given class 104 is completed, the compiler 58 continues processing classes 104 as described above with reference to steps 802-810 until each class 104 is processed.

Conclusion

The present invention can be implemented as a computer program product that includes a computer program mechanism embedded in a computer readable storage medium. For instance, the computer program product could include the program modules shown in FIG. 1. These program modules may be stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

For example, in the case of multithreaded programs, the invariant in preferred embodiments of the present invention must hold on method entry and exit and for every object 108 whose lock is not held by any thread. Furthermore, in preferred embodiment all references to the array and integer of a field pair must be contained in a synchronized block that synchronizes on the object 108 containing the array and integer. Similarly, when executing step 810, the reads of the array and integer must be contained in a single synchronized block that synchronizes on the object 108 containing the field pair.

What is claimed is:

1. A method of generating code for a computer program having instructions and an object, said instructions referencing two or more fields of said object, comprising:
identifying a field pair of the object, said field pair including an integer field and an array field;
determining that the field pair has a predefined invariant relationship by reference to one or more instructions that access the field pair; and
generating machine code for the computer program in accordance with whether the field pair has the predefined invariant relationship.

2. The method of claim 1, wherein the computer program is written in a language having modularity properties, and further comprising:
determining a subset of the computer program that is checked for the one or more instructions that access the field pair in accordance with the modularity properties.

3. The method of claim 2, wherein the subset of the computer program comprises a method of the computer program.

4. The method of claim 1, wherein the access comprises one of a read of the integer field, a read of the array field, a modification of the integer field, a modification of the array field, and an adjustment of a length of the array field.

5. The method of claim 1, wherein said identifying includes
establishing that a modification of only one of the integer field and the array field does not occur between a read of said array field and a read of said integer field.

6. The method of claim 5, wherein the modification of only one of the integer field and the array field is presumed when a call to a method of indeterminate content occurs between the read of the said array field and the read of said integer field.

7. The method of claim 1, wherein said identifying includes
establishing that when the access comprises the array being set to a newly allocated array, a new length of the array is set by a function of a form:
x′=c1*x+c2,
said c1 being greater than or equal to 1, said c2 being greater than or equal to 0, said x being one of a length of the array before being set to the newly allocated array and a value of the integer field, and said x′ being a version of said x.

8. The method of claim 1, wherein said identifying includes
establishing that when the access comprises the array being set to another array, the integer is set to zero or a new length of the array after the array is set to said another array.

9. The method of claim 1, wherein said identifying includes
establishing that when the access comprises the integer field being reduced by an amount, said access takes place in an instruction that is executed after a branch instruction in which the value of said integer field is confirmed to be less than or equal to a length of the array field plus said amount.

10. The method of claim 1, wherein said identifying includes
establishing that when the access comprises the integer field being reduced by a first amount and said access takes place in a second instruction that is preceded by a first instruction in which a length of the array field is increased by a second amount, said second amount is greater than or equal to said first amount.

11. The method of claim 1, wherein said determining includes determining whether the array field is equal to a null value.

12. The method of claim 1, wherein said determining includes
establishing that the integer field is greater than or equal to 0 and that said integer field is less than or equal to a length of the array field upon entry to and upon exit from each method included in the computer program.

13. The method of claim 1, wherein said determining includes
applying a standard value-range technique to an index of a reference of the array to establish that the index is non-negative and less than or equal to a length of the array.

14. The method of claim 13, wherein said generating includes
bypassing the inclusion of a bounds check in the computer program when it is established that the index is non-negative and less than or equal to a length of the array.

15. A method of generating code for a computer program including an object, comprising
proving that an invariant relationship between an array and an integer of the object, in which one of a) said array being equal to a null value and b) said integer being greater than or equal to 0 and said integer being less than or equal to a length of said array, is true upon entry to and upon exit from each method included in the computer program; and
generating machine code for the computer program such that a step of including a bounds check corresponding to the array and the integer is bypassed when the invariant relationship is proven.

16. The method of claim 15, wherein said proving includes
establishing that a modification of only one of the integer and the array does not occur between a read of the integer and a read of the array.

17. The method of claim 16, wherein
the modification of only one of the integer and the array is presumed when a call to a method of the computer program of indeterminate content occurs between the read of said integer and the read of said array.

18. The method of claim 17, wherein the modification comprises an adjustment of a length of the array.

19. The method of claim 15, wherein said proving includes
establishing that a reduction of the integer by an amount takes place after a confirmation of said integer being less than or equal to said amount plus a length of the array.

20. The method of claim 15, wherein the computer program is written in a language having modularity properties, and further comprising
determining a subset of the computer program that is checked to prove the invariant relationship in accordance with the modularity properties.

21. The method of claim 20, wherein the subset of the computer program includes a method of the computer program.

22. The method of claim 15, said proving includes
applying a standard value-range technique to an index of a reference of the array to establish that the index is non-negative and less than or equal to a length of the array.

23. The method of claim 15, said proving includes
establishing that when the array is set to a newly allocated array, a new length of the array is set by a function of a form:
x′=c1*x+c2,
said c1 being greater than or equal to 1, said c2 being greater than or equal to 0, said x being one of a length of the array before being set to the newly allocated array and a value of the integer field, and said x′ being a version of said x.

24. The method of claim 15, wherein said identifying includes
establishing that when the array is set to another array, the integer is set to zero or a new length of the array after the array is set to said another array.

25. A method of generating code for a computer program having an object, comprising
establishing a list of one or more possible field pairs, a possible field pair comprising an array field and an integer field of the object;
scanning a portion of the computer program for references to the one or more possible field pairs;
removing from the list, each possible field pair corresponding to an invalid combination of references, said invalid combination of references precluding confirmation of an invariant relationship of a possible field pair;
confirming the invariant relationship of a possible field pair remaining on the list, said possible field pair remaining on the list comprising an actual field pair; and
generating machine code for the computer program such that a step of including a bounds check corresponding to the actual field pair is bypassed when the invariant relationship is confirmed.

26. The method of claim 25, wherein
the references comprise one of a read of a field from the one or more possible field pairs, a modification of the field, and an adjustment of a length of the array field from the one or more possible field pairs.

27. The method of claim 25, wherein
an invalid combination of references comprises a modification of only one field of a possible field pair between a read of the array field and a read of the integer field of said possible field pair.

28. The method of claim 27, wherein
the modification of the only one field of the possible field pair is presumed when a call to a method of the computer program of indeterminate content occurs between the read of the array field and the read of the integer field of said possible field pair.

29. The method of claim 25, wherein
an invalid combination of references comprises a reduction of the integer field of a possible field pair by an amount taking place after a confirmation of said integer field being greater than said amount plus a length of the array field of said possible field pair.

30. The method of claim 25, wherein
an invalid combination of references comprises a reduction of the integer field of a possible field pair by a first amount being preceded by an increase in a length of the array field of said possible field pair by a second amount when said second amount is less than said first amount.

31. The method of claim 25, wherein
an invalid combination of references comprises the array being set to a newly allocated array and one of a call to a method of indeterminate content, a branch instruction, a write to the array, and an assignment to the array or the integers, when combination is not separated by a new length of the array being set by a function of a form:
x′=c1*x+c2,
said c1 being greater than or equal to 1, said c2 being greater than or equal to 0, said x being one of a length of the array.

32. The method of claim 25, wherein
an invalid combination of references comprises the array being set to another array and one of a call to a method of indeterminate content, a branch instruction, a write to the array, and an assignment to the array or the integer, when the combination is not separated by the integer being set to zero or a new length of the array after the array is set to said another array.

33. The method of claim 25, wherein said confirming includes determining whether the array field of a possible field pair is equal to a null value.

34. The method of claim 25, wherein said confirming includes
establishing that the integer field of a possible field pair is greater than or equal to 0 and that said integer field is less than or equal to a length of the array field of said possible field pair.

35. The method of claim 25, wherein said confirming includes
applying a standard value-range technique to an index of a reference of the array to establish that the index is non-negative and less than or equal to a length of the array.

36. The method of claim 25, wherein the computer program is written in a language having modularity properties, and further comprising
determining the portion of the computer program that is subject to said scanning in accordance with the modularity properties.

37. The method of claim 36, wherein
the portion of the computer program includes a method of the computer program.

38. A computer program product for use in conjunction with a computer system, the computer program product comprising a computer readable storage medium and a computer program mechanism embedded therein, the computer program mechanism comprising:
instructions that identify a field pair of an object included in a computer program, said field pair including an integer field and an array field;
instructions that determine that the field pair has a predefined invariant relationship by reference to one or more instructions that access the field pair; and
instructions that generate machine code for the computer program in accordance with whether the field pair has the predefined invariant relationship.

39. A computer program product for use in conjunction with a computer system the computer program product comprising a computer readable storage medium and a computer program mechanism embedded therein, the computer program mechanism comprising:
instructions that prove an invariant relationship between an array and an integer of an object included in a computer program in which one of a) said array being equal to a null value and b) said integer being greater than or equal to 0 and said integer being less than or equal to a length of said array is true; and
instructions that generate machine code for the computer program such that a step of including a bounds check corresponding to the array and the integer is bypassed when the invariant relationship is proven.

40. A computer program product for use in conjunction with a computer system, the computer program product comprising a computer readable storage medium and a computer program mechanism embedded therein, the computer program mechanism comprising:
instructions that establish a list of one or more possible field pairs, a possible field pair comprising an array field and an integer field of an object included in a computer program;
instructions that scan a portion of the computer program for references to the one or more possible field pairs;
instructions that remove from the list, each possible field pair corresponding to an invalid combination of references, said invalid combination of references precluding confirmation of an invariant relationship of a possible field pair;
instructions that confirm the invariant relationship of a possible field pair remaining on the list, said possible field pair remaining on the list comprising an actual field pair; and
instructions that generate machine code for the computer program such that a step of including a bounds check corresponding to the actual field pair is bypassed when the invariant relationship is confirmed.

41. A computer system for generating code for a computer program having instructions, the instructions referencing one or more fields of one or more objects comprising:
a memory to store instructions and data;
a processor to execute the instructions stored in the memory;
the memory storing
instructions that identify a field pair of an object included in a computer program, said field pair including an integer field and an array field;
instructions that determine that the field pair has a predefined invariant relationship by reference to one or more instructions that access the field pair; and
instructions that generate machine code for the computer program in accordance with whether the field pair has the predefined invariant relationship.

42. A computer system for generating code for a computer program having instructions, the instructions referencing one or more fields of one or more objects comprising:
a memory to store instructions and data;
a processor to execute the instructions stored in the memory;
the memory storing
instructions that prove an invariant relationship between an array and an integer of an object included in a computer program in which one of a) said array being equal to a null value and b) said integer being greater than or equal to 0 and said integer being less than or equal to a length of said array is true; and
instructions that generate machine code for the computer program such that a step of including a bounds check corresponding to the array and the integer is bypassed when the invariant relationship is proven.

43. A computer system for generating code for a computer program having instructions, the instructions referencing one or more fields of one or more objects comprising:
a memory to store instructions and data;
a processor to execute the instructions stored in the memory;
the memory storing
instructions that establish a list of one or more possible field pairs, a possible field pair comprising an array field and an integer field of an object included in a computer program;
instructions that scan a portion of the computer program for references to the one or more possible field pairs;
instructions that remove from the list, each possible field pair corresponding to an invalid combination of references, said invalid combination of references precluding confirmation of an invariant relationship of a possible field pair;
instructions that confirm the invariant relationship of a possible field pair remaining on the list, said possible field pair remaining on the list comprising an actual field pair; and
instructions that generate machine code for the computer program such that a step of including a bounds check corresponding to the actual field pair is bypassed when the invariant relationship is confirmed.
